(19) United States
(12) Patent Application Publication
(10) Pub. No.: US 2024/0055304 A1
(43) Pub. Date: Feb. 15, 2024

(54) Method and device for optimizing an amount of testing with respect to a total test time

(71) Applicant: Robert Bosch GmbH, Stuttgart (DE)

(72) Inventors: Sebastian Bayer, Schoenaich (DE); Michel Janus, Kirchentellinsfurt (DE)

(21) Appl. No.: 18/448,262

(22) Filed: Aug. 11, 2023

(30) Foreign Application Priority Data
Aug. 11, 2022 (DE) 10 2022 208 388.1

(51) Int. Cl. H01L 21/66

(52) U.S. Cl. CPC H01L 22/20

(57) ABSTRACT

A method is for determining a reduced first amount of testing from a second amount of testing. The method includes provision of a binary matrix, and optimization of a cost function, which is dependent on test variables. Each of test of the second amount of testing is associated with a test variable, and the test variable characterizes whether the test is relevant. The cost function defines constraints: a first constraint is defined in that a result of a matrix/vector multiplication must be greater than or equal to a vector comprising only ones. The matrix of the matrix/vector multiplication is a matrix whose entries all have the value one. The entries of the binary matrix are subtracted, and the vector of matrix/vector multiplication is a vector comprising the test variables. A second constraint is defined in that the test variables are binary.

This application claims priority under 35 U.S.C. § 119 to patent application no. DE 10 2022 208 388.1, filed on Aug. 11, 2022 in Germany, the disclosure of which is incorporated herein by reference in its entirety.

The disclosure relates to a method for determining a reduced amount of testing from a greater amount of testing by means of linear optimization for reducing the total test time without significant loss of reliability of a total test result, a device, a computer program and a machine readable storage medium.

### BACKGROUND

The linear optimization or linear programming is concerned with the optimization of linear target functions over a possible solution amount that is constrained by linear equations and inequalities. Linear programs (LPs) can often be used to solve problems for which no specially developed solution methods are known, for example traffic or telecommunications network planning or production planning. The linear optimization is a special case of convex optimization and the basis for several solution methods in integer linear and non-linear optimization.

### SUMMARY

The disclosure has the advantage that a particularly efficient minimum amount of testing is found and thus a reduction of the total test time can be achieved. For the minimum amount of testing, both a reduction in total test time and a retention of a reliability of a statement of all tests of the minimum amount versus all tests is achieved. That is to say, with consistent reliability, faulty products can be found by the reduced amount of testing.

In a first aspect, the disclosure relates to a computer-implemented method for determining a reduced first amount of testing from a second amount of testing, in particular the reduction is made with respect to a minimum total test duration. The first amount thus represents a subset of the second amount which requires a minimum total test time and still achieves the same reliability for locating defective or faulty products. The products may be from the same production line or different production lines. The products may be any manufacturing product, preferably the products are semiconductor components, such as chips, memory, or sensors. It should be noted that the second amount of testing preferably has various tests suitable for (production) defects or incorrect behavior of the products or other errors or product deficiencies.

The method begins with providing a matrix (\tilde{D}) whose entries characterize whether a product associated with the respective entry has passed or failed a second amount of testing associated with that entry. The matrix (\tilde{D}) may also be referred to as a binary matrix because its entries represent a decision as to whether the respective test has passed or failed. Preferably, the matrix (\tilde{D}) contains only defective products, i.e., products for which at least one test failed.

Thereafter, optimization, in particular minimization, follows a cost function. Optimization is done with respect to test variables (xⱼ). The cost function is dependent on the test variables (xⱼ), wherein each of the tests of the second amount of testing is associated with a test variable (xⱼ), and the test variable (xⱼ) characterizes whether the test is relevant to the reduced first amount. Preferably, the cost function is a sum over the test variables. Particularly preferably, the test variables are weighted with one weighting associated with the respective test variables. Preferably, the weightings are test durations or test costs (c) of the individual tests, i.e., the cost function then characterizes a total test duration or total costs depending on the test variables. It should be noted that in the event that the test durations are not known, they can be set to a common standard value, such as 1. When all weightings are set to the default value, the number of tests to be performed is effectively minimized.

Solving the optimization problem or minimizing the cost function may be performed using known mathematical optimization algorithms. Preferably, binary integer programming or integer programming or linear programming is used. Gradient descent procedures are also conceivable.

For the cost function, optimization constraints are defined. A first constraint is defined in that a result of matrix/vector multiplication must be greater than or equal to a vector having only ones, wherein the matrix of matrix/vector multiplication is a matrix whose entries all have the value one and from these entries the entries of matrix (\tilde{D}) are subtracted and the vector of matrix/vector multiplication is a vector comprising the test variables. A second constraint is defined in that the test variables are binary, i.e., can only take one of two different values, e.g., either the value 0 or the value 1 and in this case the value 1 can characterize that the test is relevant and the test for the value 0 is not relevant or redundant.

This is followed by an output of the amount of testing whose test variables characterize these tests as relevant to the first amount of testing.

It is proposed that a group of tests be defined using a predeterminable subset of the second amount of testing. For the group of tests, the entries of the matrix (\tilde{D}) are offset against each other for the products by a logical AND operation. Then all test results from the group of tests except for one test from the group are removed from the matrix (\tilde{D}). It should be noted that the test results of the remaining test in the matrix for the products are set to the result of the AND operation. In the cost function, if the test durations of the test variables are weighted, then the weightings of the tests of the group of tests may be added together to form a weighting for the remaining, unremoved test from the matrix. This has the advantage that framework conditions such as “test procedures require grouping of tests” or “times are only known for a group of tests” may be considered. That is to say, if a test machine performs multiple tests and it is not possible to separate these tests or perform only one of the tests, then this further development of the disclosure may take into account this framework condition when optimizing.

It is further suggested that for a given test variable in the second constraint, it is defined that this may only take on a value that characterizes that the test associated with this test variable is relevant to the first amount of testing. This can be done, for example, by setting the value of the given test variable to the value 1. This procedure has the advantage that tests can be defined that must be present in the second amount of testing. These necessary tests may arise from requirements such that these tests are necessary for safety aspects or prevent possible damage to measuring devices.

Furthermore, it is proposed that for a third amount of testing whose test variable characterizes that the tests are not relevant to the first amount of testing, it is tested whether one of the tests is a necessary test. The third amount of testing is thus the amount of testing remaining when the first amount of testing is withdrawn from the second amount of testing. The necessary test is added to the first amount of testing output, wherein new test data is collected based on this modified amount of testing, and depending on the new test data, the method of the first aspect is performed again, wherein the test variable of the necessary test is set to the value 1, for example, as explained above. A necessary test may be understood to mean a test that must be performed for a variety of reasons. Advantageous here is that the optimization is iterative over several interactions with a test system and thus ultimately a minimum amount of necessary tests can be found.

It is further proposed that the first constraint be relaxed so that at most a pre-determinable number of defective products may be present after applying the tests of the first amount of testing. It is advantageous here that with a test series obtained from this approach, a derived test series can be defined in which at most the pre-determinable number of NOK products is available—(NOK=not OK, erroneous). Surprisingly, it turned out that by allowing a small error rate (e.g., 0.1 ppm), a further significant reduction of the total test time can be achieved. A value of the error rate may depend on a domain in which the products are to be used, on safety aspects or production costs, for example 0.1 ppm may be useful for automotive applications, whereas for consumer electronics, an error rate of already 1 ppm may be acceptable.

Furthermore, it is proposed that entries of the matrix be predicted based on previously acquired (further) test results of the products. The prediction may be performed using known machine learning methods.

Furthermore, it is proposed that the method of the first aspect of the disclosure is performed multiple times for a steadily increasing amount of data points, wherein after each performance of the method, it is checked whether the amount of non-relevant tests stabilizes. Once the amount has stabilized, it can be assumed that a reasonable first amount of testing has been found.

In further aspects, the disclosure relates to an apparatus and to a computer program, which are each configured to perform the aforementioned methods, and to a machine-readable storage medium on which said computer program is stored.

### BRIEF DESCRIPTION OF THE DRAWINGS

Embodiments of the disclosure are explained in greater detail below with reference to the accompanying drawings. In the drawings:

FIG. 1 schematically illustrates a flow chart of one embodiment of the disclosure.

### DETAILED DESCRIPTION

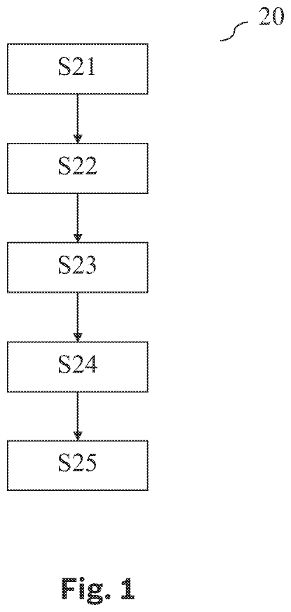

FIG. 1 schematically shows a flow chart (20) of an embodiment of a method for determining a reduced first amount of testing from a second amount of testing. Preferably, the first amount is optimized to achieve a minimum total test duration while maintaining accuracy for locating defective or incorrectly manufactured products compared to the second amount of testing.

The method starts with optional step S21. Herein, the tests of the second amount of testing are performed for a plurality of products. The test results obtained with these tests are summarized in the form of a matrix D. For example, the columns of the matrix D are each assigned a test from the second amount of testing, and the rows are each assigned a product, wherein the entries are the corresponding test results or measured values. The products may be manufactured products in a factory, such as semiconductor components. The tests may be performed directly after a manufacturing step of the products. For the exemplary embodiment that the products are semiconductor components, the tests may include, for example, Wafer level tests or final level tests.

Preferably, when performing the tests of the second amount of testing, it is measured how long they take to complete. These measurements are also hereinafter referred to as test durations or execution times of the tests.

This is followed by optional step S22. This determines which of the products have passed all of the tests from step S21 and removes those rows of products that passed the tests from the matrix D. That is to say, that only test results of products that are NOK are available.

Step S23 then follows. All test results of the matrix D are replaced by a value that characterizes whether the respective test was passed based on the test result. Preferably, the individual test results of the products that have passed the respective tests are replaced with a 1, otherwise with a 0. It is also conceivable that the matrix D with the replaced values are be provided in step S23. Accordingly, after step S23, there is a matrix \tilde{D} that has binary entries whose entries individually characterize a test decision in terms of failed or passed. Passing a test may be given if the test result or the measured value is within a given range of values or below/above a given barrier.

It should be noted that a sequence of steps S22 and S23 can easily be interchanged.

Step S24 is then performed. In this step, an optimization problem to be minimized is solved. This is done by minimizing a cost function. The cost function is dependent on the test variables, wherein each of the tests of the second amount of testing is associated with a variable (xⱼ), and the test variable (xⱼ) characterizes whether the test is relevant. The following optimization constraints are defined for the cost function:

A first constraint is defined in that a result of matrix/vector multiplication must be greater than or equal to a ones vector 1_{ñ}, wherein the matrix of the matrix/vector multiplication is selected from a matrix whose entries all have the value 1, the entries of the replaced matrix are subtracted, and the vector of matrix/vector multiplication is a vector comprising the test variables.

A second constraint is defined in that the test variables are binary.

The optimization problem with the first and second constraint may be mathematically given as follows:

$${min}_{x} {c}^{′} x$$

$$s . t . ( 1 - \tilde{D} ) x \geq {1}_{\tilde{n}}$$

$${x}_{j} ∈ \{ 0 , 1 \} ,$$

$$∀ j ∈ 1 , … , k$$

wherein c is a weighting of the test variable.

After step S24 has completed, an output S25 of the results of the minimization from step S24 follows. In this case, the first amount of testing is output, wherein the first amount contains the tests whose test variables characterize that the test is relevant.

Optionally, the reduced test amount from step S25 may be used. That is to say, a test sequence is determined based on the first amount of testing output from step S25 and a manufactured product is tested using this test sequence and, if applicable, released for further processing or shipping/sales if it passes these tests. In other words, in step S25, products are tested with the tests of the first amount of testing output, in particular to locate defective or faulty products.

In a preferred embodiment of the method according to FIG. 1, the first constraint is modified as follows: A pmin operator is 1_{ñ} applied to the two matrices of matrix/vector multiplication and the ones vector, and a result of the pmin operator is 1_{ñ} multiplied by the ones vector, wherein the result thereof must be greater than or equal to a number of NOK products ñ minus a given number t of defective products. The pmin operator is also known as “parallel-min” operator. The pmin operator determines the column-by-column minimum of an amount of vectors of equal length. It is noted that the number of products ñ corresponds to the number of products from the matrix \tilde{D} so that the dimensions match.

This modified first constraint condition may be mathematically given as follows:

pmin((1−\tilde{D})x,1_{ñ})′1_{ñ}≥ñ−t

The term ñ−t assures that at most t products fail the tests. It should be noted that the first constraint above is present for t=0. A value for t may be given, or may be a fraction of ñ, e.g. t=0.0000001 ñ to allow 0.1 ppm of defective products.

What is claimed is:

1. A method for determining a reduced first amount of testing from a second amount of testing, comprises:
provisioning a matrix having a plurality of entries characterizing whether a product associated with a respective entry of the plurality of entries has passed or failed the second amount of testing associated with the respective entry;
optimizing a cost function dependent on test variables, wherein each test of the second amount of testing is associated with one of the test variables, and the test variables characterize whether a corresponding test of the second amount of testing is relevant;
defining constraints for the cost function by:
defining a first constraint in that a result of matrix/vector multiplication must be greater than or equal to a vector having only ones, wherein the matrix of matrix/vector multiplication is from a matrix having entries that all have the value one, the plurality of entries of the provisioned matrix are subtracted and the vector of matrix/vector multiplication is a vector comprising the test variables, and
defining a second constraint in that the test variables are binary; and
outputting an amount of the testing whose test variables are characterized as relevant.

2. The method according to claim 1, wherein:
a group of tests is defined by a predeterminable subset of the second amount of testing, and
for the group of tests, the plurality of entries of the provisioned matrix are each calculated with one another for products by a logical AND operation, and all test results of the group of tests are removed from the provisioned matrix except for one test from the group.

3. The method according to claim 1, wherein it is defined for a given test variable in the second constraint, that the given test variable may only take on a value that characterizes that the test associated with the given test variable as being relevant to the first amount of testing.

4. The method according to claim 3, wherein:
for a third amount of testing whose test variable characterizes that the tests are not relevant to the first amount of testing, checking whether one of the tests is a necessary test,
the necessary test is added to the output amount of testing,
new test data is collected based on a modified amount of testing, and depending on the new test data, at least the provisioning of the matrix, the optimizing the cost function, and the defining the constraints are performed again, and
a test variable of the necessary test is set as relevant to the first amount of testing by the second constraint.

5. The method according to claim 1, wherein the first constraint is relaxed so that at most a pre-determinable number of defective products is present after applying the tests of the first amount of testing.

6. The method according to claim 5, wherein:
the relaxation of the first constraint is given by applying a pₘᵢₙ operator to the two matrices of matrix/vector multiplication and the vector comprising only ones, and multiplying a result of the pₘᵢₙ operator by the vector comprising only ones to obtain a result, and
the result must be greater than or equal to a number of products minus a given number of the defective products.

7. The method according to claim 1, wherein entries of the provisioned matrix are predicted based on previously recorded test results of the product.

8. The method according to claim 1, wherein an apparatus is configured to perform the method.

9. The method according to claim 1, wherein a computer program comprises commands that, when the computer program is executed by a computer, cause the computer to perform the method.

10. The method according to claim 9, wherein the computer program is stored on a non-transitory machine-readable storage medium.
